(19) United States
(12) Patent Application Publication
(10) Pub. No.: US 2026/0093603 A1
(43) Pub. Date: Apr. 2, 2026

(54) SYSTEMS AND METHODS FOR DETECTING CODE DEFECTS

(71) Applicant: Digital Age Quality Assurance Corp., Novato, CA (US)

(72) Inventors: Ben Wibberley, Novato, CA (US); Devin Seto, Novato, CA (US); Timothy Hudson, Novato, CA (US); Jake Hamilton-Daynes, Novato, CA (US)

(21) Appl. No.: 19/346,121

(22) Filed: Sep. 30, 2025

Related U.S. Application Data
(60) Provisional application No. 63/701,264, filed on Sep. 30, 2024.

(51) Int. Cl. G06F 11/362; G06F 11/34

(52) U.S. Cl. CPC G06F 11/3636; G06F 11/3414; G06F 11/3438

(57) ABSTRACT

A system is described herein comprising client and server applications configured to record gameplay data of a game title during real time gameplay of a user, wherein the gameplay data includes video capture including audio, user webcam video, user audio data, and one or more gameplay metrics, wherein the one or more gameplay metrics comprises performance data and gameplay controller input data, capture the gameplay data of one or more segments of the recording, compile the one or more gameplay metrics of the one or more segments into a corresponding video file, process the video capture and the user webcam video, synchronize the compiled video file for each of the one or more gameplay metrics with the video capture and the webcam video, and provide the synchronized information for replay.

### RELATED APPLICATION

This application claims the benefit of U.S. Application No. 63/701,264, filed Sep. 30, 2025.

### TECHNICAL FIELD

Embodiments are described herein relating to debugging of software, under an embodiment.

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### BACKGROUND

For software, debugging tactics involve interactive debugging, control flow analysis, log file analysis, monitoring at the application or system level, memory dumps, and profiling. Many programming languages and software development tools also offer programs to aid in debugging, known as debuggers. A system and method for identifying coding defects is described herein.

### BRIEF DESCRIPTION OF THE FIGURES

FIG. 1 shows a tester view screen flow, under an embodiment.

FIG. 2 shows a login screen, under an embodiment.

FIG. 3 shows a my account screen, under an embodiment.

FIG. 4 shows a my projects screen, under an embodiment.

FIG. 5 shows a project details modal, under an embodiment.

FIG. 6 shows a support screen, under an embodiment.

FIG. 7 shows a notifications modal, under an embodiment.

FIG. 8 shows a client manager screen flow, under an embodiment.

FIG. 9 shows a login screen, under an embodiment.

FIG. 10 shows a licenses screen, under an embodiment.

FIG. 11 shows a license details modal, under an embodiment.

FIG. 12 shows a request seats modal, under an embodiment.

FIG. 13 shows a projects screen, under an embodiment.

FIG. 14 shows a projects details modal, under an embodiment.

FIG. 15 shows a testers screen-licensed tab, under an embodiment.

FIG. 16 shows a user details modal, under an embodiment.

FIG. 17 shows an assign seat modal, under an embodiment.

FIG. 18 shows a testers screen-unlicensed tab, under an embodiment.

FIG. 19 shows a invite users modal, under an embodiment.

FIG. 20 shows a DAQA admin screen flow, under an embodiment.

FIG. 21 shows a login screen, under an embodiment.

FIG. 22 shows a clients screen, under an embodiment.

FIG. 23 shows a add client modal, under an embodiment.

FIG. 24 shows a company details modal, under an embodiment.

FIG. 25 shows an add license modal, under an embodiment.

FIG. 26 shows a license plans screen, under an embodiment.

FIG. 27 shows an add license plan modal, under an embodiment.

FIG. 28 shows a license plan details modal, under an embodiment.

FIG. 29 shows a seat requests screen, under an embodiment.

FIG. 30 shows a DAQA screen, under an embodiment.

FIG. 31 shows a “Sign In” page, under an embodiment.

FIG. 32 shows a “Select Application” screen, under an embodiment.

FIG. 33 shows an “Sessions” screen, under an embodiment.

FIG. 34-36 shows “Settings” screens, under an embodiment.

FIG. 37 shows a “Recording” screen, under an embodiment.

FIG. 38 shows a “Recording” screen, under an embodiment.

FIG. 39 shows a recorded session, under an embodiment.

FIG. 40 shows a recording/testing session, under an embodiment.

FIG. 40 shows a screen allowing a user to select which window is subject to sharing with a collaboration participant, under an embodiment.

FIG. 41 illustrates what the collaboration participant would see when the participant joins via the link, under an embodiment.

FIG. 42 shows an application session management screen, under an embodiment.

FIG. 43 shows a screen allowing a user to select which window is subject to sharing with a collaboration participant, under an embodiment.

FIG. 44 shows an event viewing screen, under an embodiment.

FIG. 45 shows a system for capturing gameplay data, under an embodiment.

### DETAILED DESCRIPTION

A Test Operations Modification (TopMod) kit is described herein. TopMod (referred to herein as TopMod QA) is a software system used by Digital Age Quality Assurance (DAQA) “special forces” testers to manage test plans, direct test focus, capture and track software defects, and automate specific functions.

TopMod QA is under an embodiment a self-contained toolkit, comprised of complimentary systems, which provide DAQA testers with the ability to efficiently and intelligently perform test activities, well above the capabilities of typical black box testers.

TopMod QA comprises a player recording and defect management system. It includes a set of tools to quickly and easily capture defects, along with all the elements necessary to identify the root cause and collaborate around each issue.

TopMod QA consists of a local client-side utility (“client”), a hosted service (“server”) designed to capture all aspects of a QA tester's experience with a given game title, and a web application (“dashboard”) in which users can review their captured tests. It not only captures general performance data of the game, such as frame rate, CPU and GPU usage, but also user inputs and webcam & microphone video & audio of the QA tester. All of this information is compiled and presented within a User Interface inside the dashboard.

Top Mod QA Technologies include:

```
• Wails [https://wails.io]
  ∘ GoLang [https://go.dev]
  ∘ ReactJS [https://react.dev]
• MySQL
• Protobuffers [https://protobuf.dev]
• FFMPEG [https://www.ffmpeg.org]
• Presentmon [https://github.com/GameTechDev/PresentMon]
• Rust [https://www.rust-lang.org]
• Vue.js [https://vuejs.org/]
• Vuetify [https://vuetifyjs.com/]
```

Wails is a framework that enables users to create desktop applications using web technologies such as HTML, CSS, and JavaScript. The framework is built on top of Go (otherwise known as GoLang) and uses the Go standard library to provide an easy-to-use API for creating desktop applications. With Wails, users can build cross-platform applications that run on Windows, macOS, and Linux.

One of the key benefits of Wails is that it allows one to use existing web development skills to create desktop applications. Users can implement web development tools and frameworks such as React (further described below), Vue, and Angular to build an application's front-end. Additionally, because Wails uses Go for the back-end, users receive performance benefits of a compiled language.

React (also known as React .js or ReactJS) is a front-end JavaScript library for building user interfaces based on components. It is maintained by Meta (formerly Facebook) and a community of individual developers and companies. React can be used to develop single-page, mobile, or server-rendered applications with frameworks like Next .js. Because React is only concerned with the user interface and rendering components to the Document Object Model (DOM), React applications often rely on libraries for routing and other client-side functionality.

MySQL is an open-source relational database management system (RDBMS)

Protobuffers (or Protocol Buffers) is an open-source cross-platform data format used to serialize structured data. It is useful in developing programs that communicate with each other over a network or for storing data. Protocol buffers provide a serialization format for packets of typed, structured data that are up to a few megabytes in size. The format is suitable for both ephemeral network traffic and long-term data storage. Protocol buffers can be extended with new information without invalidating existing data or requiring code to be updated.

FFMPEG is an open-source software project consisting of a suite of libraries and programs for handling video, audio, and other multimedia files and streams. It is designed for processing video and audio files. It is widely used for format transcoding, basic editing (trimming and concatenation), video scaling, video post-production effects, and standards compliance.

PresentMon presents frame rates, frame times, and a host of other metrics in real-time—or logged over a period—for almost any game. It supports DirectX 9 through 12, OpenGL and Vulkan, and it's available for Windows 10 and 11.

Rust is an advanced systems programming language. Rust is widely accepted for its focus on memory safety, performance, and concurrency. It combines low-level control over hardware with high-level abstractions, enabling developers to write reliable and efficient software.

C++ is a high-level, general-purpose programming language. C++ offers object-oriented, generic, and functional features, in addition to facilities for low-level memory manipulation for systems like microcomputers or to make operating systems like Linux or Windows.

Vue .js is a progressive JavaScript framework designed for building user interfaces and single-page applications. Vuetify is a comprehensive Material Design framework for Vue .js that provides a set of pre-built UI components and tools to create responsive web applications.

### Top Mod QA Components Include:

```
• Server
  ∘ Debian 12
  ∘ Docker
    ▪ MySQL 8.1
    ▪ TURN (Traversal Using Relays around NAT) Service
    ▪ Collaboration Handler Service
    ▪ TopMod QA Backend Service
    ▪ Sharepoint Integration Service
    ▪ License Service
• Client
  ∘ Wails Application
    ▪ UI/UX
      • ReactJs
    ▪ Logic
      • GoLang
    ▪ SubProcesses
      • PresentMon Binary
      • FFmpeg Binary
      • Screen Capture Binary
      • Screenshot Binary
      • Audio Capture Binary
      • Gamepad Capture Binary
• Dashboard
  ∘ Vue/Vuetify
```

Under an alternative embodiment, the server components comprise the following:

```
• Server
  ∘ Kubernetes
    ▪ TopMod QA Compositor Service
  ∘ Debian 12
    ▪ FFmpeg
    ▪ GoLang
    ▪ Docker
      • MySQL
      • Collaboration Handler Service
        ∘ Collaboration Frontend
        ∘ Broadcast Backend (Handles communication via TURN)
        ∘ TURN (Traversal Using Relays around NAT) service
      • TopMod QA Backend Service (API handling communications
        between client applicant and database)
      • Transcription Service
        ∘ Whisper
      • License Service
      • Grafana Log Analysis
      • Promtail Log Ingestion
```

The TopMod QA client is built with the Wails framework and utilizes a combination of low level windows APIs to record performance data directly via the Wails application, and indirectly through purpose-built binaries in languages other than GoLang such as PresentMon Binary, Screen Capture Binary (Rust), ScreenShot Binary, Audio Capture Binary (Rust), and the Gamepad Capture Binary (C++) listed above.

It also hooks (injects code into the execution flow of) all user input devices such as mice, keyboards, and gamepad controllers in order to capture user inputs. Tester webcam and microphone data and performance data are also recorded during the use of the software, and at the end of each test (“session”), all of the data is converted into Protobufs and compressed for upload to the server. Note that game capture video and corresponding game audio are uploaded in their native file format.

In order to connect to (or hook into) the input devices, a system call to a Windows API is performed containing a procedure which is then injected into the code execution flow of the operating system's input device handler. This procedure surfaces the input events to TopMod QA.

Once the server receives the compressed data, it adds the session to a queue. Once a session is selected for processing, the server compiles the gameplay video and audio files (i.e. the actual gameplay video and audio that users see and hear during play) together, as well as the webcam and microphone files. Additionally, the server takes each dataset and generates a composite video and generated transcription based on the captured microphone audio. This is done by dynamically drawing individual video frames based on the performance data and user inputs and then being composited together with the webcam and game video and audio capture. Note that audio here refers to all audio captured i.e., microphone and game audio.

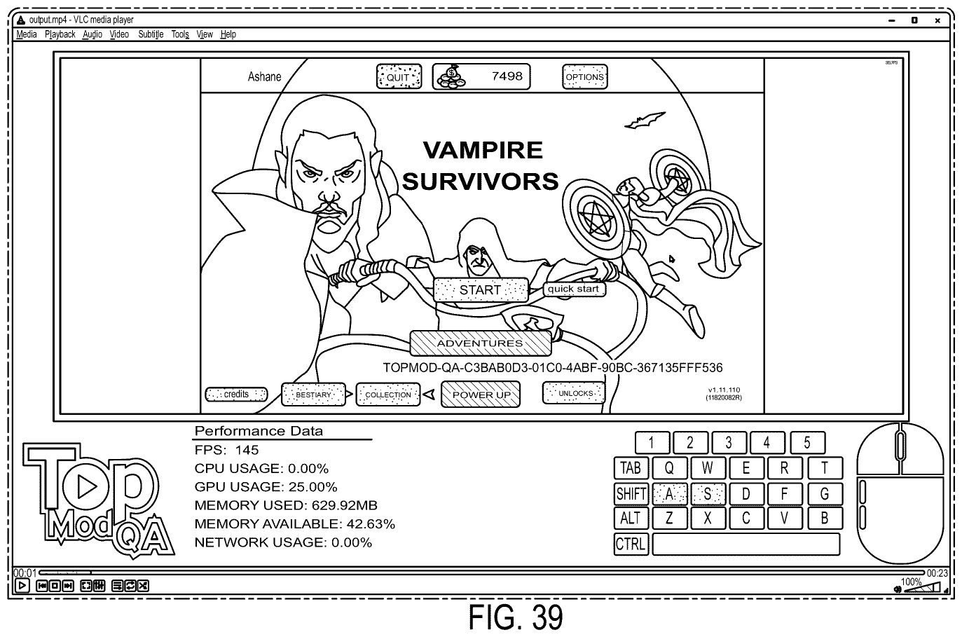

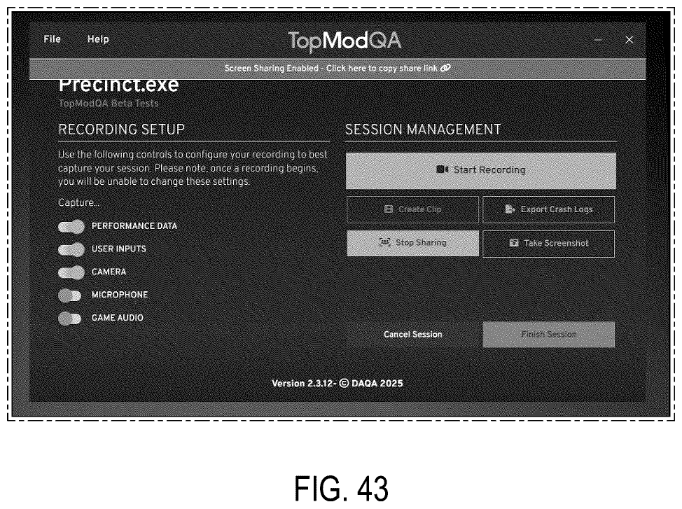

Once finished post-processing, these videos are made available for review alongside the protobuf files for performance data and user inputs within the dashboard. Users are then able to review test footage inside a webpage with transcription data, input data and performance data searchable and in-sync with video playback. (See FIG. 43). Under an alternative embodiment (as shown in FIG. 39) system playback shows all of the data captured (video, audio, inputs, performance data) in a single video file whereas FIG. 43 takes each of those and displays them in their own UI widget element. This allows for an expanded view of the data in terms of resolution and in terms of being able to view the timeline of the data being captured. The alternative only shows data from the exact second the user is watching in the video.

### TopMod QA Captured Information

Game screen
   20 fps Transport Stream video
System audio output
   96 kbps WAV
Game frame rate
   Sum of individual rendered frames in a given second
CPU utilization
   Averaged once per second
GPU utilization
   Averaged once per second
Memory utilization
   Allocated memory by the application under test read as an instantaneous value once per second
   Available, unallocated system memory read as an instantaneous value once per second
Network bandwidth utilization
   % of available throughput of the primary network adapter based on the total bytes sent in the last second, as a percentage of the current bandwidth of the adapter
Keyboard inputs
   Realtime, no aggregation
Mouse inputs
   Realtime, no aggregation
Gamepad controller inputs
   Measured at a polling rate of 60 hz (every 16.66667 ms)
Webcam video
   20 fps webm video
Microphone audio
   96 kbps OPUS

### Client Flow

A test session with TopMod QA starts with launching the client and logging in with the user's credentials.

Upon login, the user is presented with a simple interface consisting of a dropdown menu listing currently open applications, a refresh button to update the list, and a “Start Recording” button.

Once an application is selected and the “Start Recording” button is clicked, the user interface (“UI”) will update to show a traffic light system for the various recording options (“Performance”, “System Resources”, “Screen”, “Inputs”, “Webcam”, “Microphone”), a timer, a pause/resume button, a clip button, and a “Stop Recording” button. Note that a user may elect to monitor one or more of categories of captured information. However, TopMod continues to capture all such information. The traffic light system visually indicates level of TopMod application performance. For example, TopMod receives corrupted Webcam video images, the traffic light for Webcam is yellow or perhaps red based on severity of the problem.

Pressing the clip button will capture the timestamp in the recording that the button was pressed and store it for later processing dependent on the user's application settings. By default this will generate a thirty (30) second video clip from as early as thirty (30) seconds prior to the button click, to the point of button click.

Pressing the “Stop Recording” button will end the recording and begin a pre-processing step wherein the captured data is prepared for upload to the server.

Once the pre-processing step is complete, the user is taken back to the application selection screen and allowed to continue testing.

An alternative embodiment implements the following workflow:

Upon login, the user is presented with a simple interface consisting of two dropdown menus for project and target application selection, a list of recent sessions captured and a “Start Session” button.

Once a project and application are selected and the “Start Session” button is clicked, the user interface (“UI”) will update to show the Session Management screen. This screen allows users to control the various recording options (“Performance Data”, “User Inputs”, “Camera”, “Microphone”, “Game Audio”), a “Start Recording” button, a “Create Clip” button, a “Export Crash Logs” button, a “Live Share” button, a “Take Screenshot” button, a “Cancel Session” button and a “Finish Session” button. Note that a user may elect to monitor one or more of categories of captured information. Upon starting recording by clicking the “Start Recording” button, the recording options will display a “Live” display whilst recording and an “Error” display for any problems encountered during capture of that recording option. For example, TopMod receives corrupted Webcam video images, the “Error” display will be displayed.

Pressing the “Create Clip” button will present the user with a display modal showing the last 5 minutes of recording. Users are then able to assign the clip a title, set the start timestamp and end timestamp for their clip before proceeding to upload the clip to the server. By default, the start timestamp and end timestamp are set to be 30 seconds apart.

Pressing the “Export Crash Logs” button after the target game has crashed will generate a standalone file that outputs the games memory output into a log file stored on the users local machine.

Pressing the “Take Screenshot” button will present the user with a display modal showing an image capture of the current display of the target game. Users are then able to assign the screenshot a title before proceeding to upload the screenshot to the server.

Pressing the “Live Share” button will allow the user to generate a URL and start screen-sharing the target game's gameplay footage with another person.

Pressing the “Stop Recording” button will end the recording and allow the user to reconfigure their recording options for future recordings. It will also enable them to finish or cancel the session by pressing the “Cancel Session” or “Finish Session” buttons.

Pressing the “Cancel Session” button will set the session to discarded and the user will be directed to the homepage.

Pressing the “Finish Session” button will provide the user with the ability to review any recordings, screenshots or clips that they haven't already uploaded. This is done via a display modal that appears and asks the user whether they would like to upload or discard a specific recording, screenshot or clip. After reviewing all of the captured recordings, screenshots or clips, the user is then directed to the “Session Complete” screen whilst all of the files are uploaded to the server.

From the “Session Complete” screen, users are able to complete the session by pressing the “Complete Session” button and are then taken to the application homepage where they can continue testing.

### Server Processing Flow

Uploaded sessions are queued to avoid blocking resources. Once a session is selected for processing from the queue, the following steps are followed (asynchronously):

### Performance Data Processing

Each sample of performance data is bucketed into one (1) second long groups. A graphic instance is generated and the performance data for that second is drawn onto the graphic instance. Once each graphic instance has been drawn, it's saved to a PNG file, and the filename is recorded for later use. A graphic instance is simply a single graphic frame/image featuring the averaged performance data for that one (1) second. Graphic instances are drawn with respect to each type of performance data.

Once all the frames are drawn, FFMPEG is used to combine the frames into an H264 encoded mp4 video file. Under an embodiment, a frame is generated for every 1/20^{th} of a second. Each frame has on it the captured performance data (or in the case of the input processing, the drawn active inputs), and is then saved to a PNG file. So for a 10 second session, we generate 200 frames which are then combined into a video file. This video file is composited together with the others. Accordingly, twenty (20) frames (1 second) of video feature the corresponding graphic instance or rather performance data bucketed for that 1 second. After FFMPEG combines them then the video file is literally a visual of performance data in “real time”.

### Input Processing

Each user input sample is bucketed into 50 ms long groups. A graphic instance is generated and a base image applied depending on the type of input. Additional highlighting is drawn to indicate each input on the base image as per the bucketed samples. This then provides the viewer with a visual representation of the input device, with highlighting of the various inputs taking place as the video progresses.

Once each graphic instance has been drawn, it's saved to a PNG file, and the filename is recorded for later use.

Once all the frames are drawn, FFMPEG is used to combine the frames into an H264 encoded mp4 video file. The process is analogous to the generation of frames described above with respect to performance data processing.

### Webcam Processing

If there is available webcam footage, it is scaled and padded to specific dimensions consistent with the programmed layout of the output video.

### Game Capture Processing

The game screen capture video is scaled and padded to specific dimensions consistent with the programmed layout of the H264 encoded output video. Game capture includes game audio.

Once all of the above steps are completed, the individual videos are composited together, with delays calculated based on the timestamps of the first recorded samples for each given video in order to sync user inputs, processing data, webcam video, and audio to the game screen video. Audio here refers to user/tester audio and game audio. The output file is then uploaded to secondary storage for transcribing and user playback. The tester audio is encoded into the video so it can be both heard, and the transcriptions (produced via whisper) can be read and searched. Note that both tester and gameplay audio can be heard during session review; however, only tester/user audio is transcribed. Also note that the transcription is synced with the game video/audio, the webcam video, the inputs, and processing data. The output file, alongside the uploaded protobuf files, are then made accessible to the dashboard via an API for user playback.

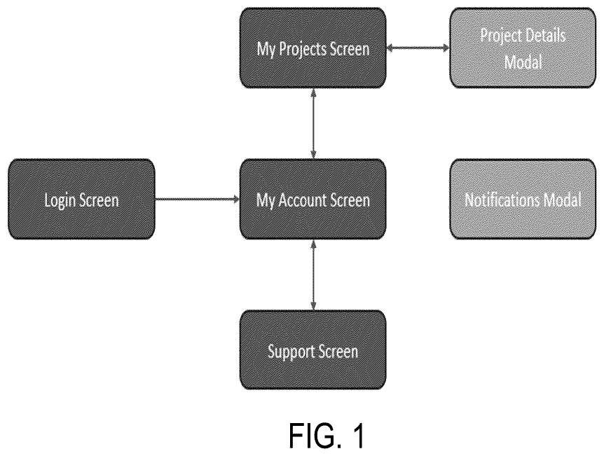

FIG. 1 shows a tester view screen flow, under an embodiment. From a login screen, a user moves to a “My Account” screen. A menu bar positioned at the top of the screen allows a user to toggle among the “My Account” screen, a “My Projects” screen, and a “Support” screen. Each screen is described in greater detail below.

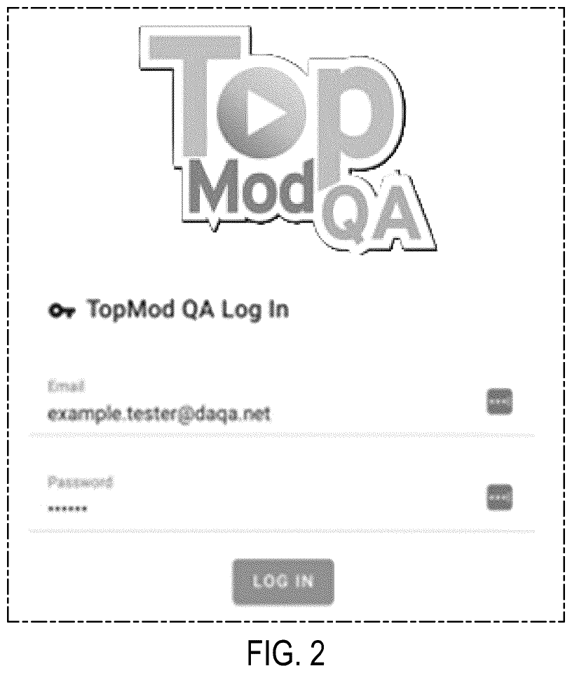

FIG. 2 shows a “Login” screen with standard username and password flow. A user is assigned by a client manager via a manager portal and users set their own password on first login.

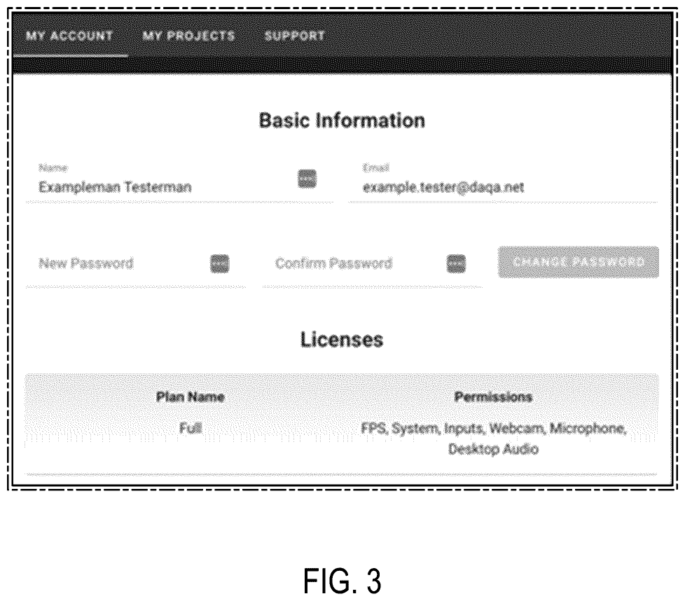

FIG. 3 shows a “My Account” screen and displays user information. User can change password. The screen shows which TopMod QA license(s) are available to this person, and which features are turned on for those licenses.

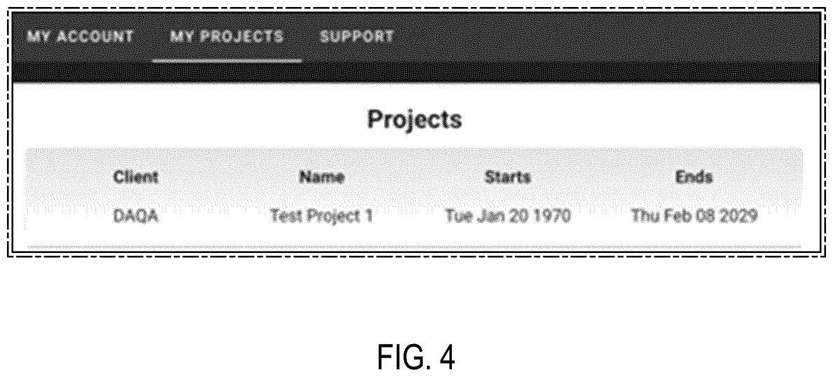

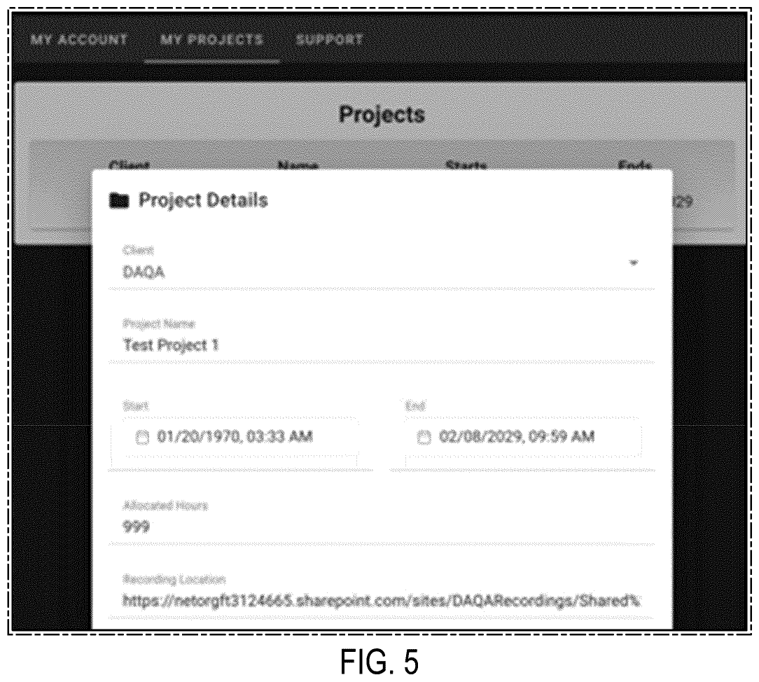

FIG. 4 shows a “My Projects” screen and displays projects assigned to a user. A user can click a project to open the project details modal (see FIG. 5).

FIG. 5 shows the “Project Details” modal and displays details about the selected project. The data is display only. Nothing can be changed from this view.

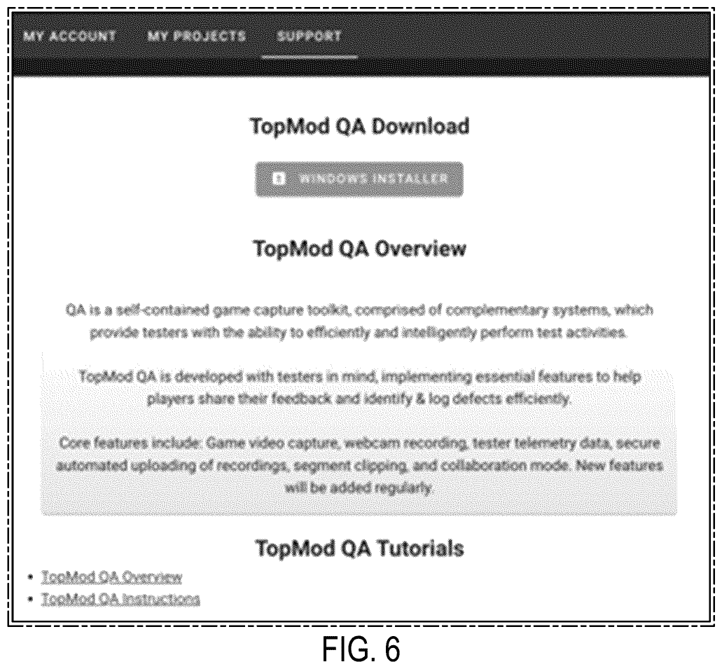

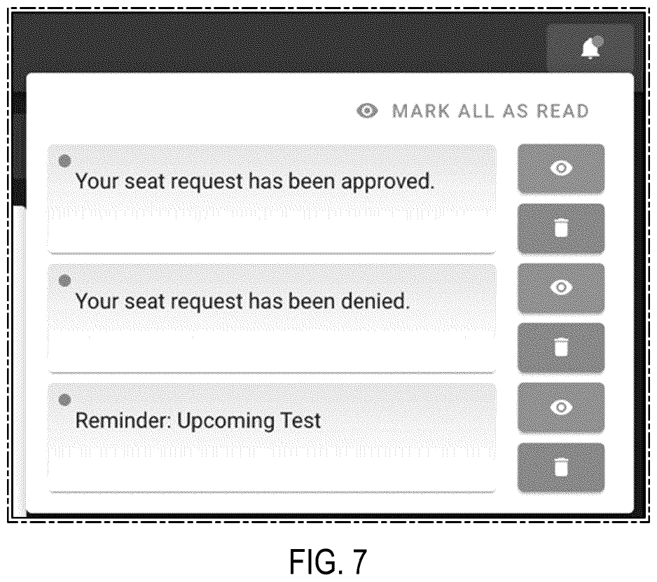

FIG. 6 shows a “Support Screen”. A blue button allows users to download the TopMod QA application. The screen also provides overview and links to tutorials, instructions, etc. FIG. 7 shows a notifications modal with the information center showing details pertinent to the user with buttons to mark as read or delete. This screen appears when the user interacts with/clicks on the notification button.

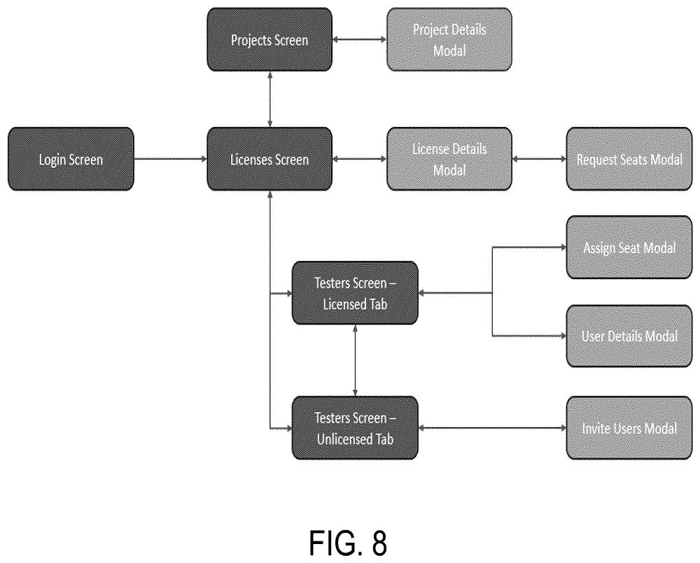

FIG. 8 shows a client manager screen flow, under an embodiment.

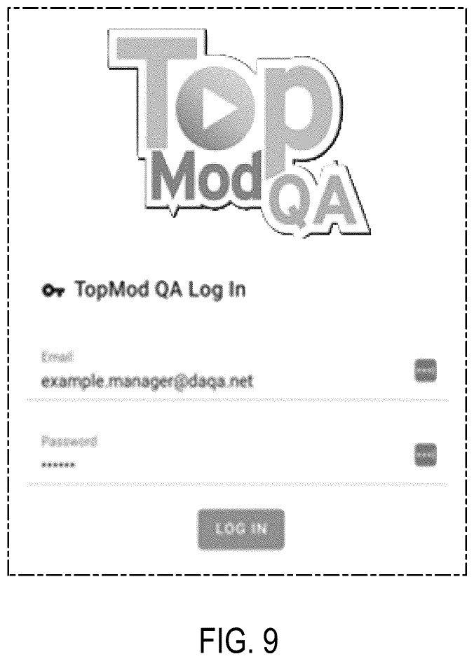

FIG. 9 shows a “Login” screen with standard username and password flow. User is assigned by DAQA, and users set their own password on first login.

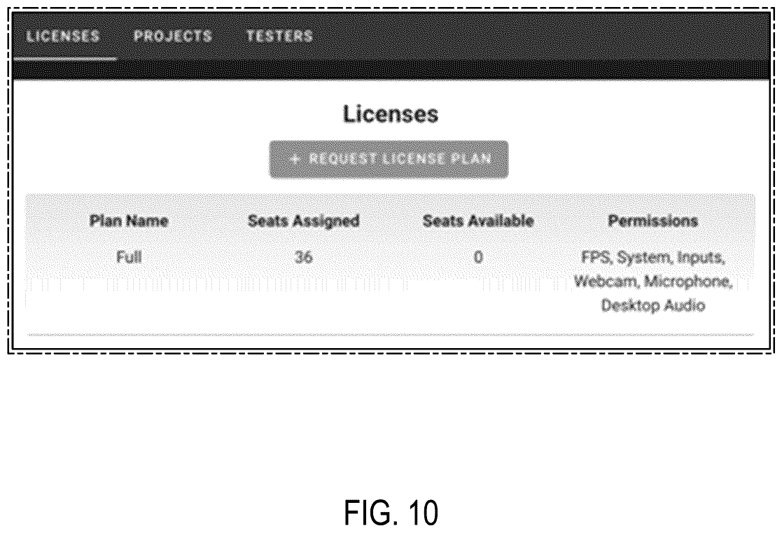

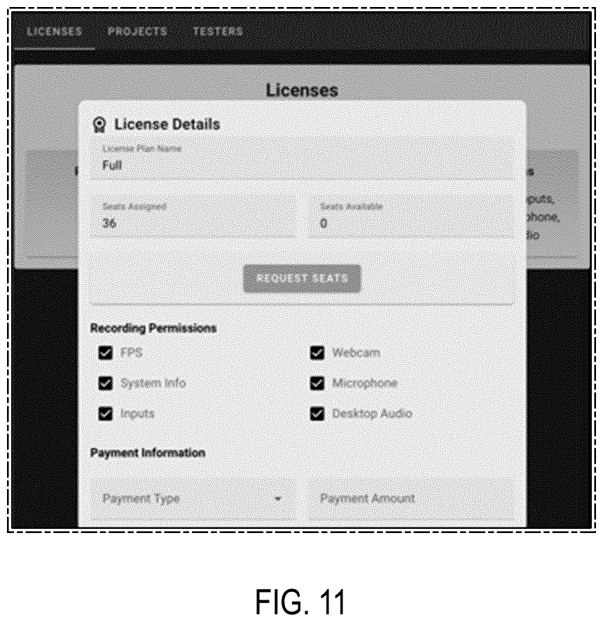

FIG. 10 shows a “Licenses” screen displaying TopMod QA licenses purchased by the client. Clients may purchase multiple licenses, and each one is listed in a separate box on this page. Details show information on each license, including number of seats assigned/available and which functions are turned on. User can click the box to bring up the license details modal (see FIG. 11). A Request License Plan brings up a simple text box where client can write a message asking for a new license type. (Note that a user may user the upper menu bar to toggle among “Licenses” screen, “Projects” screen, and “Testers” screen).

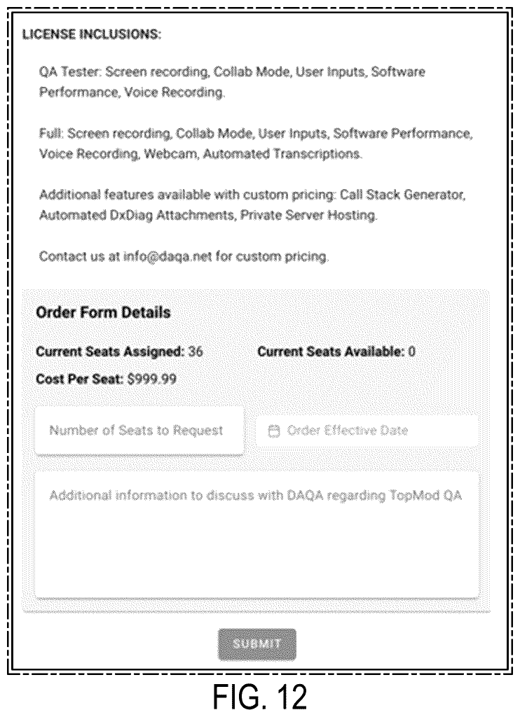

FIG. 11 shows the “License Details” modal displaying details about the selected license, including seats, features, and costs. A Request Seats button is used to request an increase in available seats for this license (see FIG. 12).

FIG. 12 shows the “Request Seats” modal providing an online order form for selected license, where client can request a number of additional seats. There is a field for effective date of license increase and a general input field for any additional information which submits an email to DAQA and creates an entry in the Admin Portal, indicating DAQA needs to review and approve. Once approved, the client is notified through the message center and the number of seats available is increased accordingly.

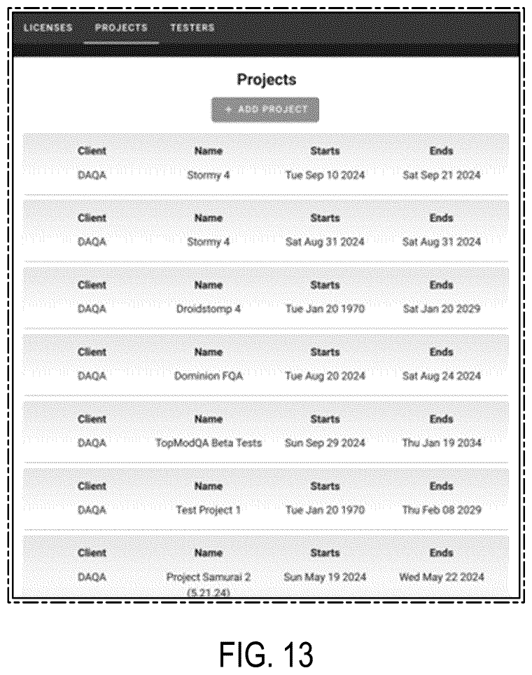

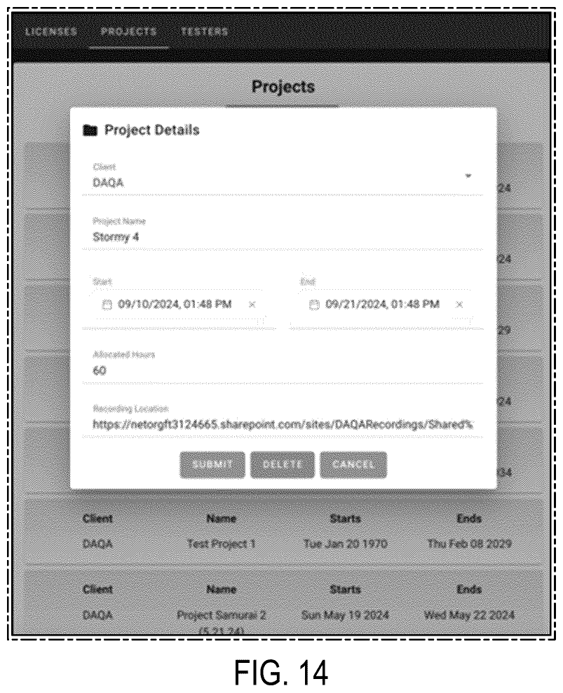

FIG. 13 shows a “Projects” screen displaying a list of any TopMod QA projects for the client (past, present, and future) and includes summary details of each project. Any box can be clicked which will open up the Project Details modal (see FIG. 14).

FIG. 14 shows the “Projects Details” modal displaying project details, including start and end date, number of recording hours, and location of recordings. Client can adjust any of these fields and submit to save the change and includes a delete button that allows client to completely delete the project entry if they so desire.

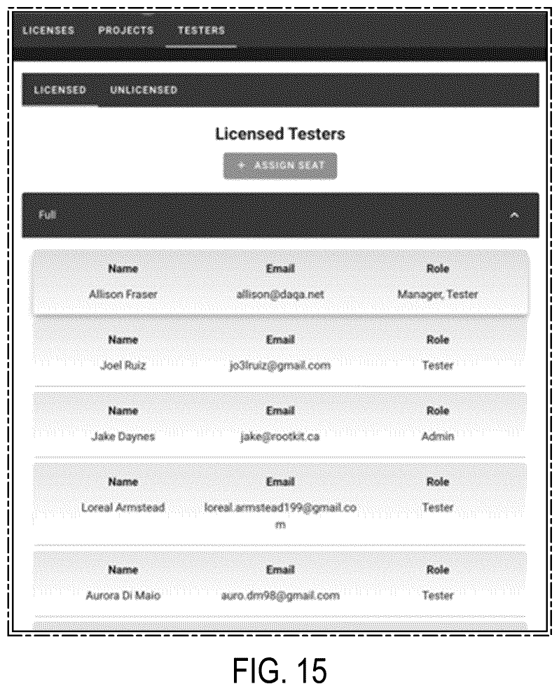

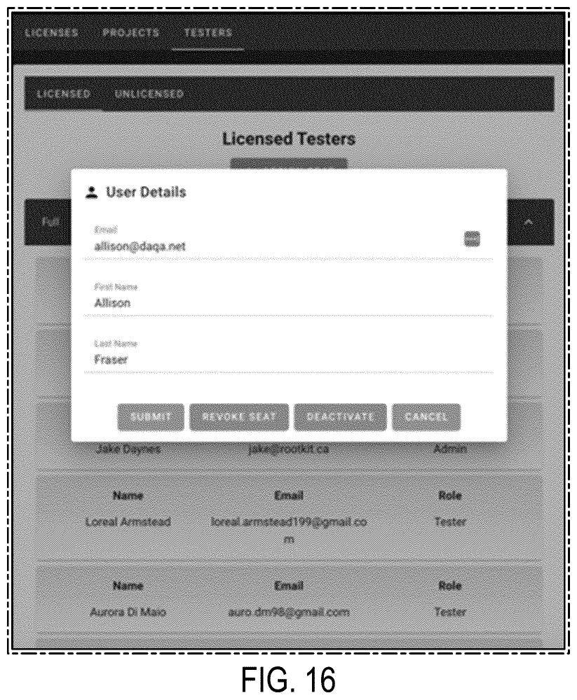

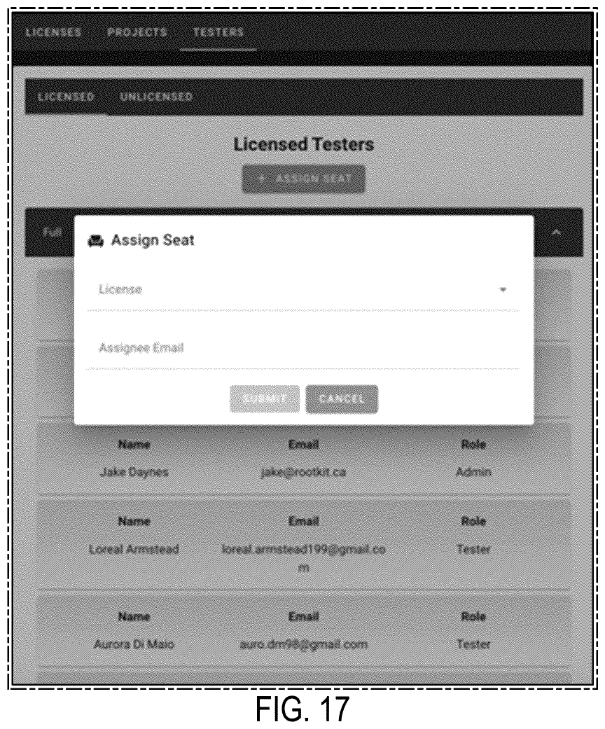

FIG. 15 shows a “Testers” screen-Licensed Tab” displaying a list of users who have seats currently assigned. Clicking a user box opens the User Details modal (see FIG. 16) and clicking+Assign Seat opens the Assign Seat modal (FIG. 17). (Note that a user may use an upper menu to toggle between licensed and unlicensed user screens).

FIG. 16 shows the “User Details” modal displaying information on the selected user and any field can be changed and saved by the client. The Revoke Seat button removes the assigned seat from that user and places it back into the available seat “pool” for that license and user entry remains in the system and can be re-assigned a license at any time. The Deactivate button removes the user entry from the system entirely and revokes their seat.

FIG. 17 shows the “Assign Seat” modal with a dropdown to select which license “pool” the seat will be assigned from. The assignee email is the user to be assigned. On submit, the user receives an email prompting them to login and the seat will be available to them upon next login.

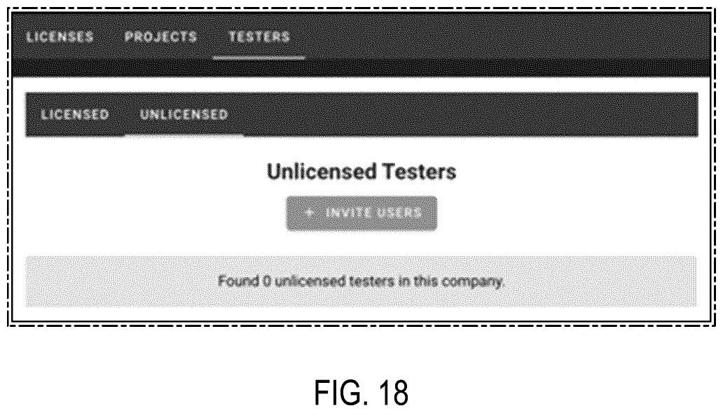

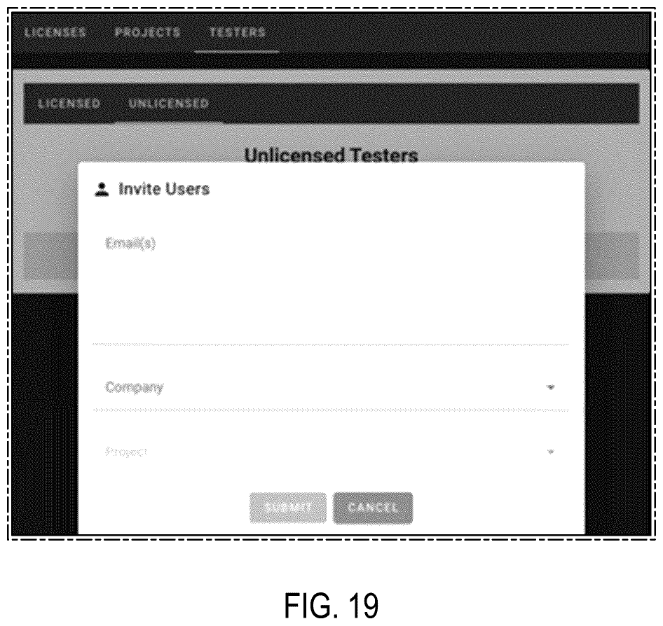

FIG. 18 shows a “Testers Screen-Unlicensed Tab” displaying a list of users who are in the system but do not have seats currently assigned. By clicking+Invite Users Seat it opens the Invite Users modal (see FIG. 19).

FIG. 19 shows the “Invite Users” modal where email address(es) of potential users can be entered into the first box. There is a company dropdown that allows client to assign them to a specific company. The project dropdown allows client to assign them to a specific game/project creating a new user entry in the Testers Screen-Licensed tab, which can allow a TopMod license to be assigned.

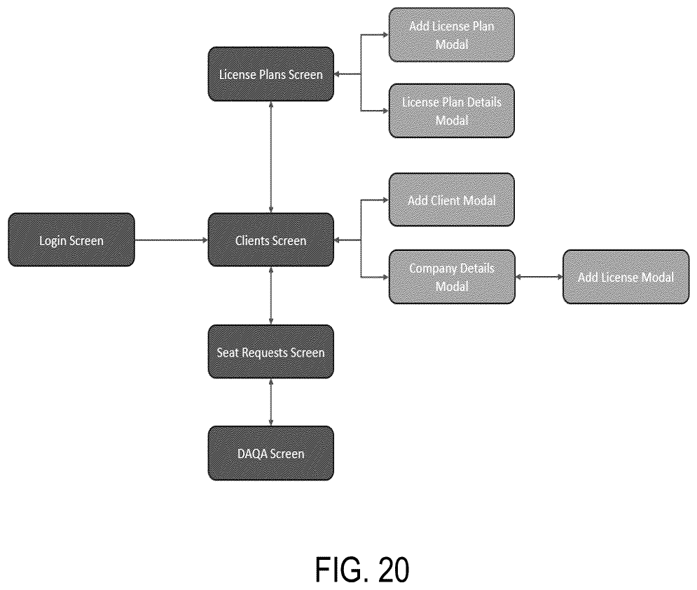

FIG. 20 shows a DAQA admin screen flow, under an embodiment.

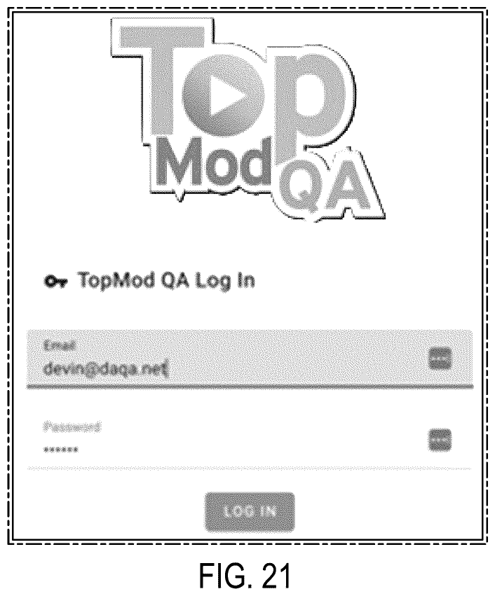

FIG. 21 shows a “Login Screen” with standard username and password flow. User is created by DAQA, and users sets their own password on first login.

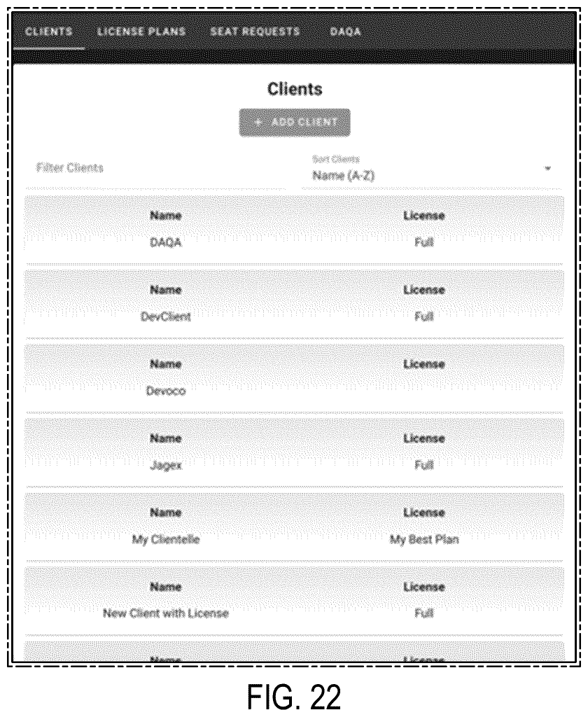

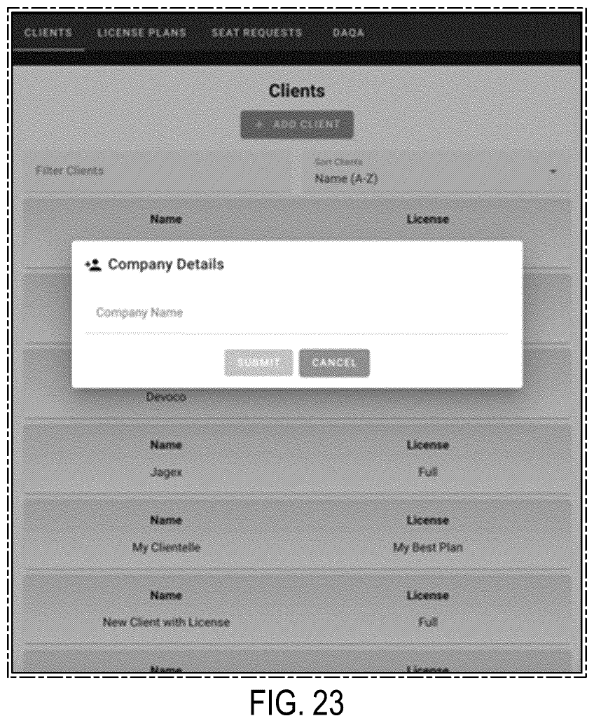

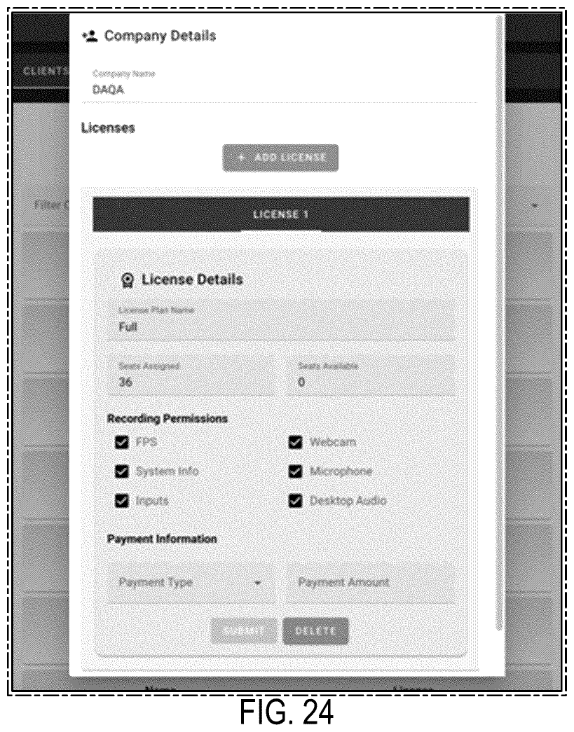

FIG. 22 shows a “Clients Screen” displaying a summary list of DAQA's TopMod QA clients and the licens(es) assigned to them. New clients can be added by clicking the +Add Client button (see FIG. 23) and any box can be clicked which will open up the Company Details modal (see FIG. 24).

FIG. 23 shows the “Add Client” modal with a simple text entry field to input new client's name.

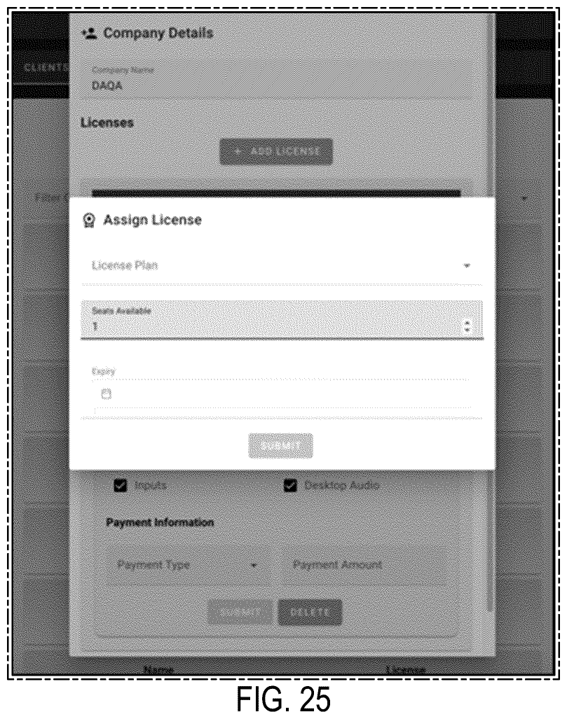

FIG. 24 shows the “Company Details” modal displaying details about the selected license, including name, seats, features available, and payment info. The payment type dropdown allows DAQA to select monthly or annually for payment frequency. The delete button removes the client from the system and clicking the +Add License button opens the Assign License modal (see FIG. 25).

FIG. 25 shows the “Assign License” modal form which allows DAQA to add additional licenses to an existing client. There is a dropdown to select which license to assign and shows seats available to assign number of seats for the license. The expiry field allows DAQA to determine when the license is turned off.

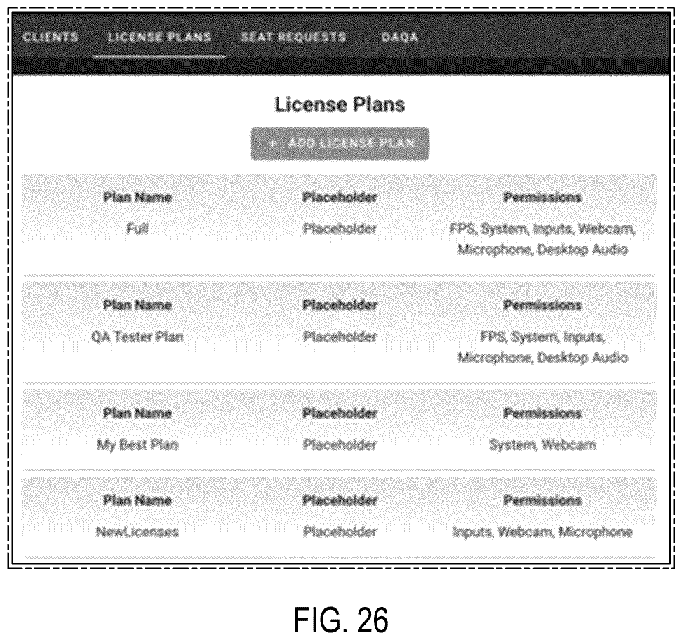

FIG. 26 shows a “License Plans” screen displaying a summary list of TopMod QA license configurations available to DAQA clients. This populates the License Plan dropdown in the Assign License modal and new licenses can be created by clicking the +Add License Plan button (see next slide). Any box can be clicked which will open up the License Plan Details modal (see 2 slides down). (Note that an upper menu allows users to toggle among Clients, License Plans, Seat Requests, and DAQA screens).

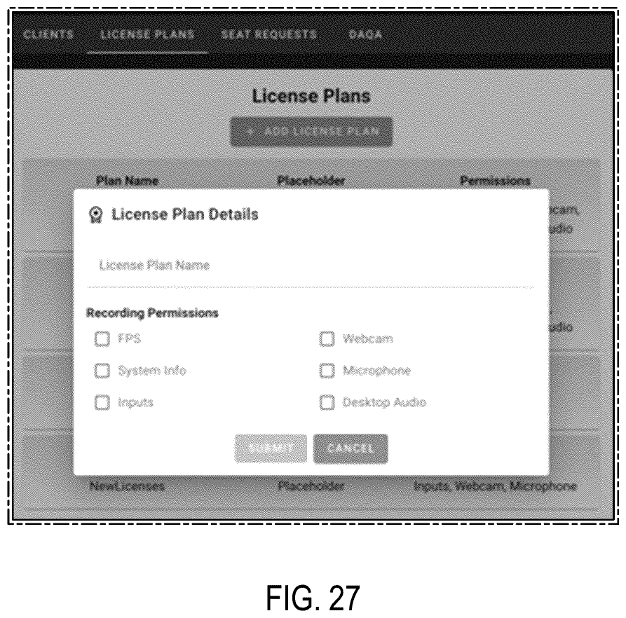

FIG. 27 shows the “Add License” plan modal with the form that allows DAQA to create and configure a new TopMod QA license. This will make it available in the License Plan dropdown menu so it can be assigned to any clients.

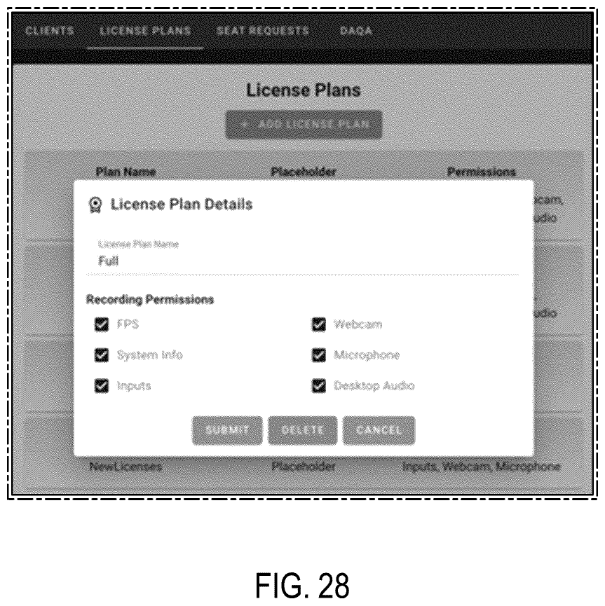

FIG. 28 shows the “License Plan” details modal displaying the configuration for the selected TopMod QA license. Any field or check box can be changed and saved and delete will permanently remove the license from the system for all clients.

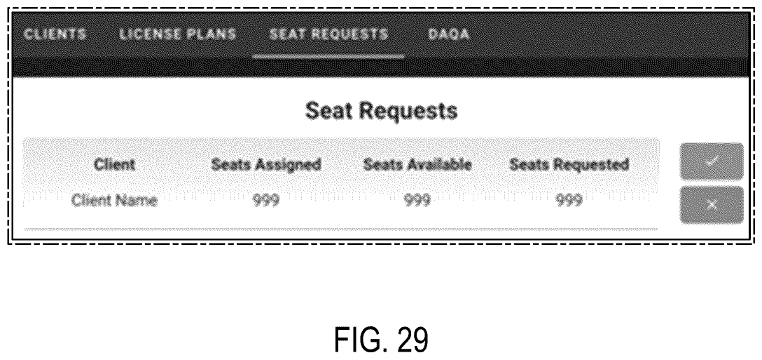

FIG. 29 shows a “Seat Requests” screen displaying information on any seat requests made through the Client Manager portal. Clicking the checkmark button will approve the request and the number of seats requested will automatically be made available to the specified client. Clicking the X button will decline the request and email the client letting them know of the decline.

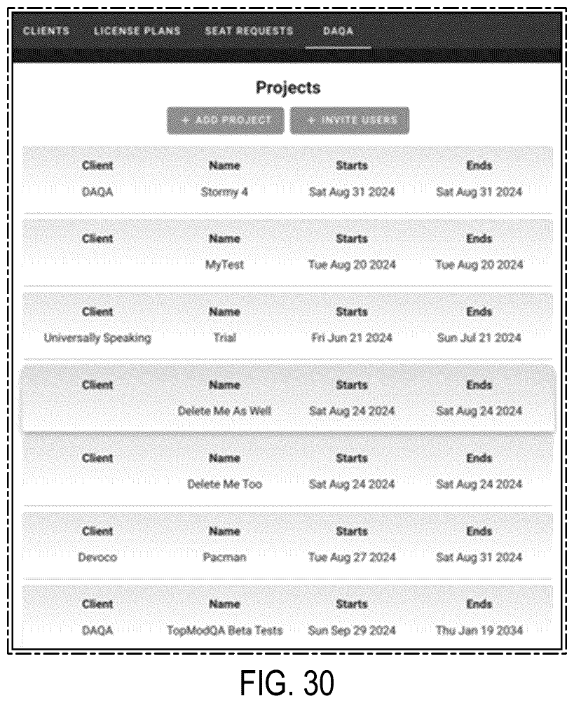

FIG. 30 shows a “DAQA” screen. This screen is ONLY for DAQA internal projects. It allows us to set up and manage our internal resources for tests that we are performing. Functionality mirrors that of the client-facing system, but is restricted for use by internal DAQA staff.

User work flow during testing/recording session is described below and illustrated in corresponding figures.

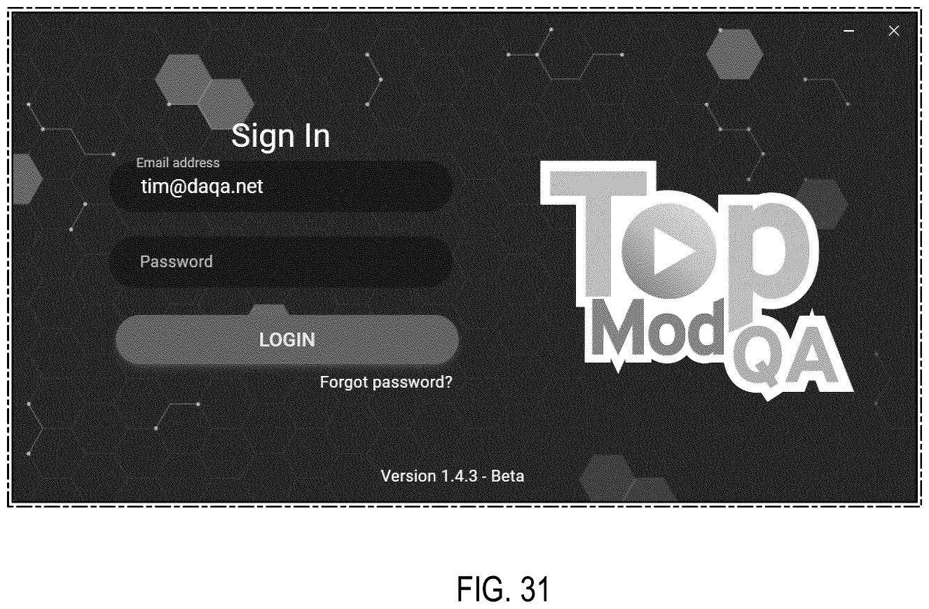

FIG. 31 shows a “Sign In” page with a forgot password link for resetting user password.

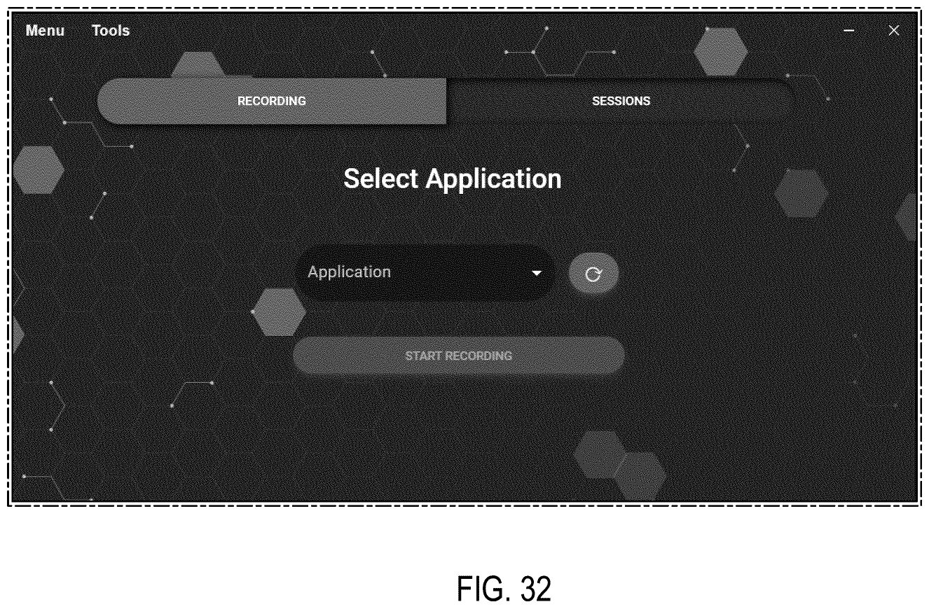

After login, FIG. 32 shows a “Select Application” screen which allows a user to toggle between a “Recording” screen and a “Sessions” screen. On the “Recording” screen, a user selects an application from a drop down menu and clicks the start recording button to begin a testing/recording session.

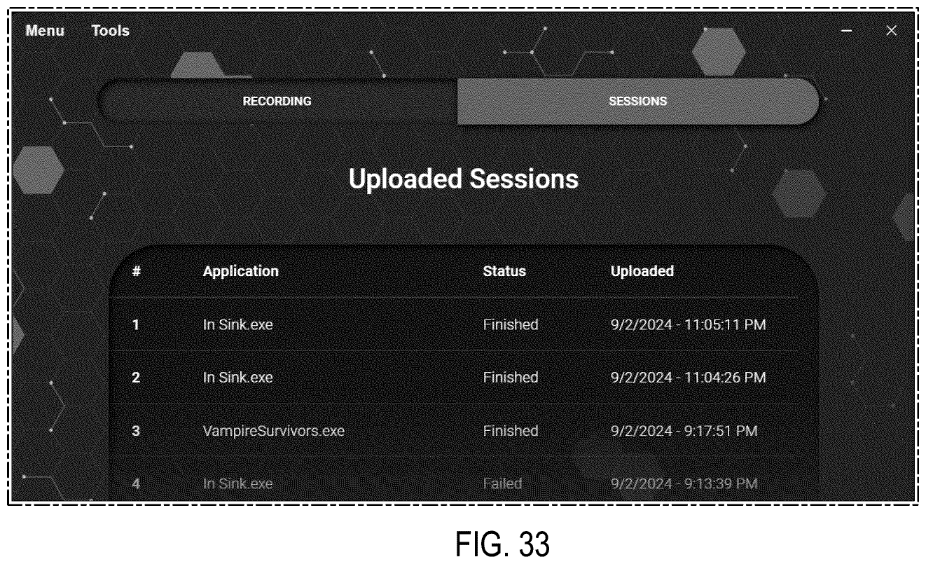

FIG. 33 illustrates a “Sessions” screen listing uploaded sessions. Each uploaded session indicates application, status (finished or fail) and time of upload. Under an embodiment, states include Pending, Processing, Finished, Failed. Pending is defined as received by the server and queued for processing. Processing is defined as when the server is actually analyzing the captured data and generating the output video. Finished means that the output video has been successfully generated and uploaded to secondary storage. Failed occurs if there has been an issue with the files such as corrupted data, or an invalid upload.

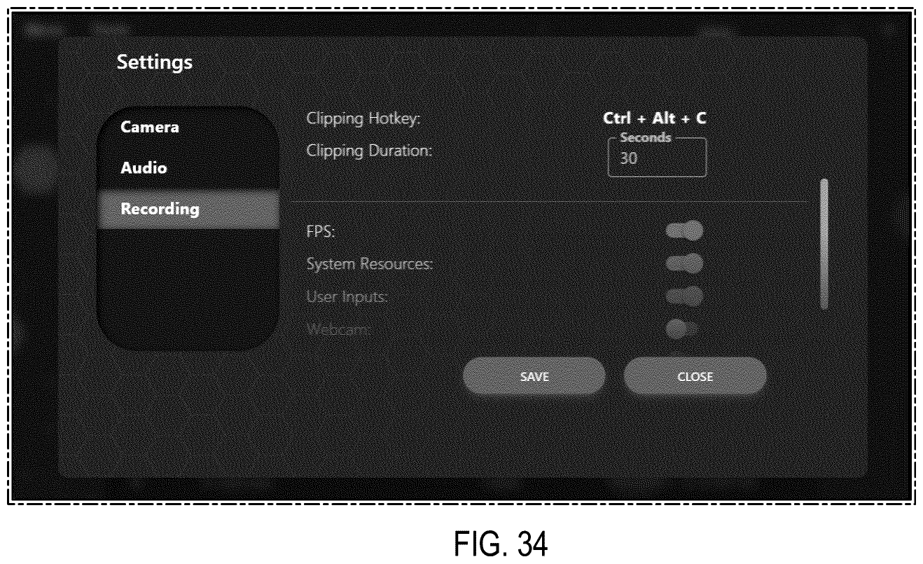

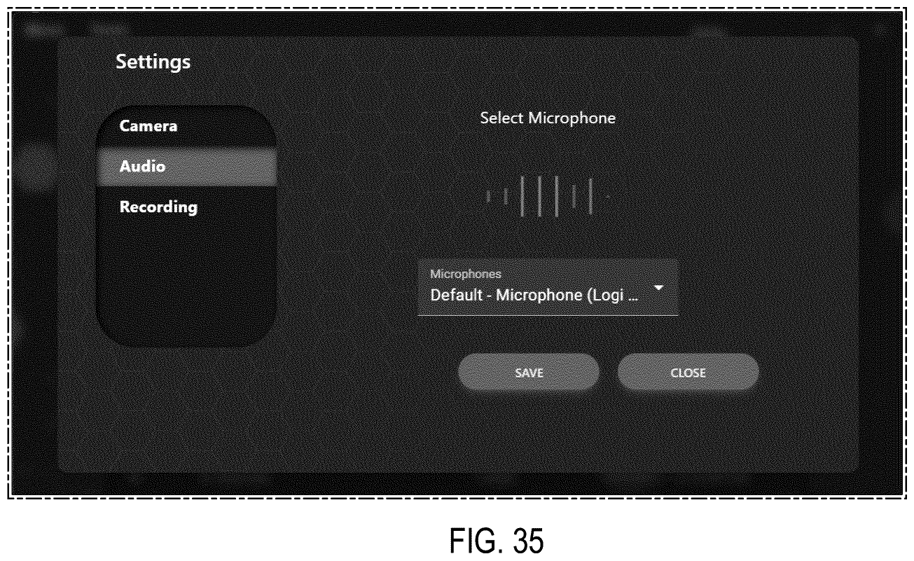

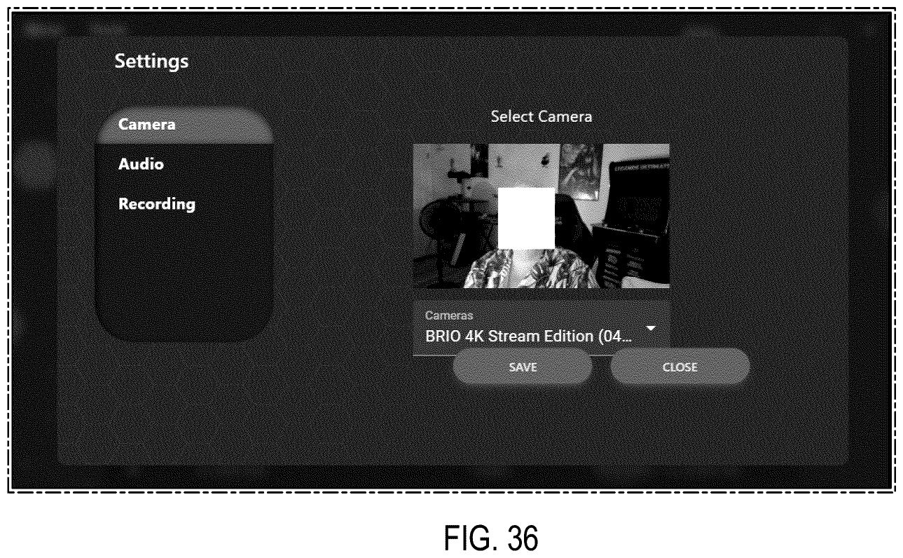

FIG. 34-36 comprise “Settings” screens. A user many toggle between camera, audio, and recording screens by clicking on corresponding buttons. The recoding screen provides clipping hotkey and clipping duration information. Both the clipping duration and the hotkey are configurable. This screen also allows a user to select monitored metrics (e.g. FPS, System Resources, User Input, Webcam, etc). The audio screen allows a user to select a microphone from a dropdown menu. In similar fashion, the camera screen allows a user to select a camera from a dropdown menu.

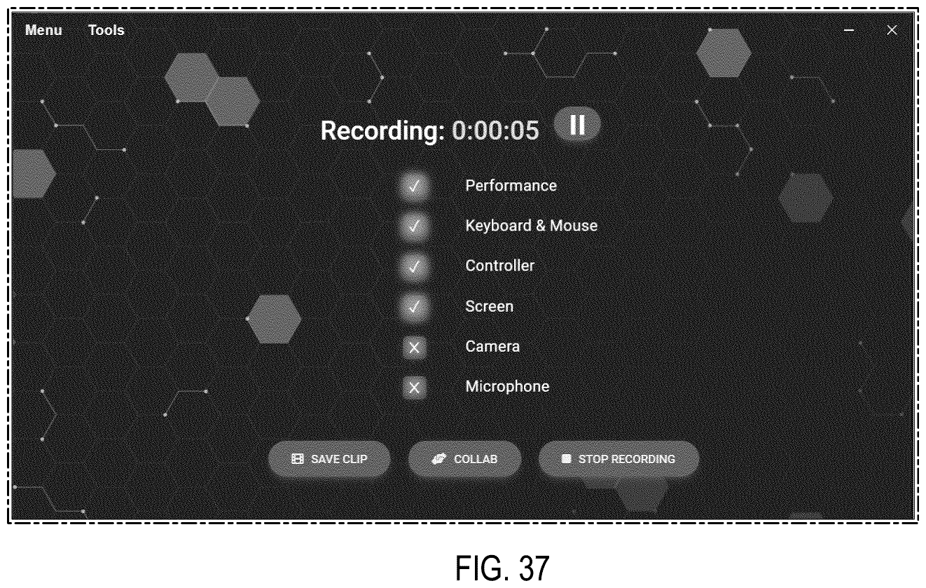

FIG. 37 shows a “Recording” screen under an embodiment. The screen is visible to a user after clicking the start recording button show in FIG. 32. This screen illustrates traffic light system for various recording options (“Performance”, “Keyboard and Mouse”, “Controller”, “Screen”, “Camera”, “Microphone”), under an embodiment. The traffic light system visually indicates level of TopMod QA application performance. Using buttons at the bottom of the screen, a user may save a clip, collaborate, or stop recording by clicking corresponding buttons.

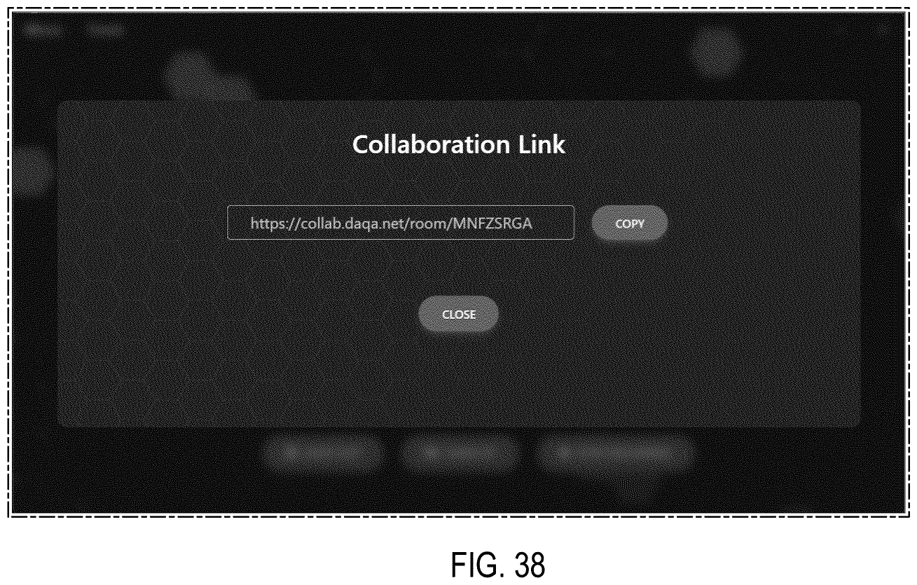

FIG. 38 shows a collaboration link which enables collaboration mode. Collaboration Mode enables a remote viewer to connect to the end user's game capture and provides two-way audio communication between both parties. This allows a tester to have a developer or more experienced tester to connect and assist them as needed. Collaboration Mode operates via a WebRTC connection using the DAQA TURN server for secure and stable communication.

FIG. 39 shows a recorded session. Under this embodiment, one views a previously recorded and uploaded gameplay testing session. The recording displays real time performance data metrics and user inputs.

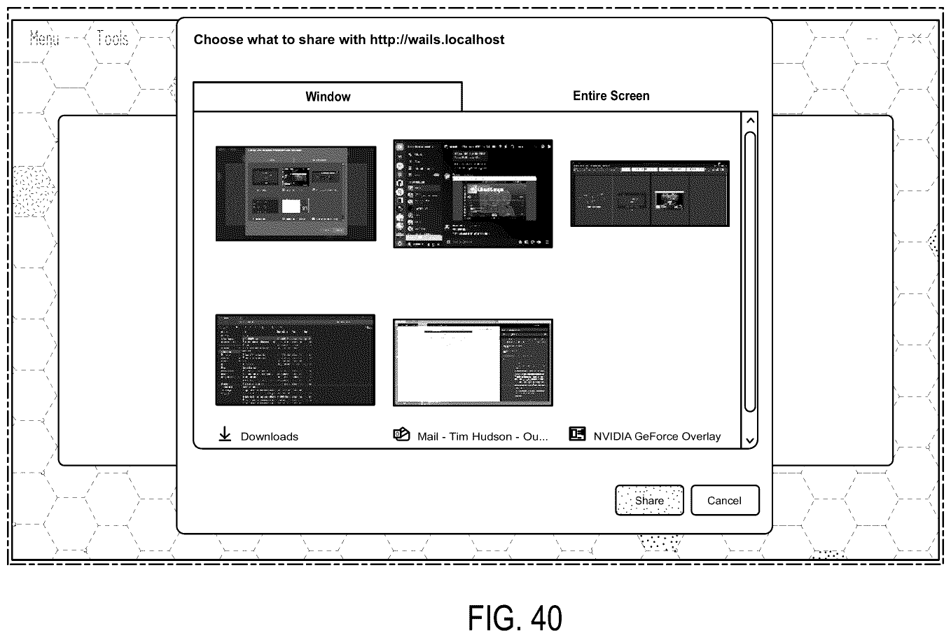

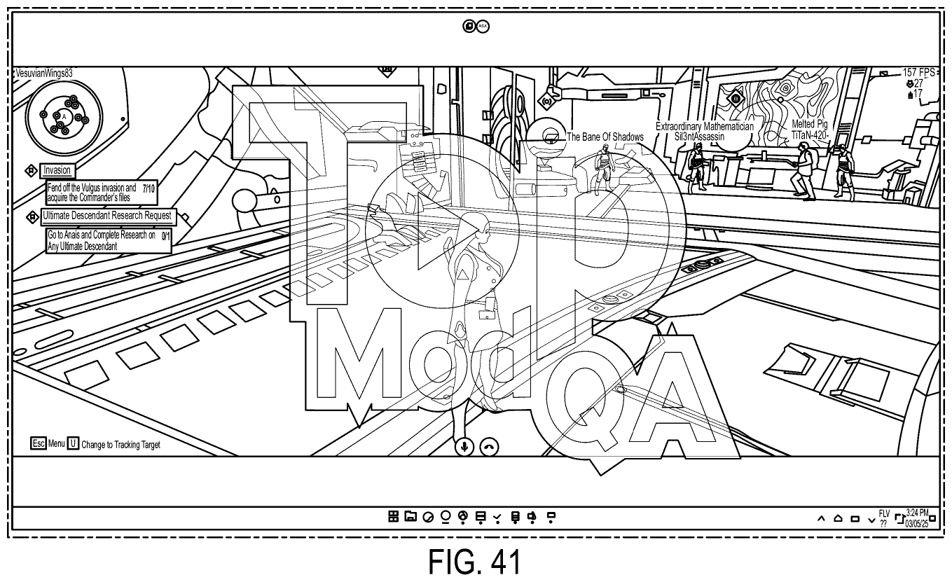

Note that the collaboration link shown in FIG. 38 directs clicks through to the screen of FIG. 40 which allows a user to select which window is subject to sharing with a collaboration participant. FIG. 41 is what the collaboration participant would see when they join via the link.

Console capture using TopMod QA leverages a standalone computing system separate to the console itself (TopMod QA Box). The physical system contains a microphone, camera, USB ports for controller connections, and two HDMI ports. The console's video output is connected to one of the HDMI ports on the TopMod QA Box, while the display is connected to the second HDMI port. Console controllers are connected to the TopMod QA Box via Bluetooth or USB, and the TopMod QA Box is then connected to the console via USB. When running a test, the TopMod QA Box receives all user inputs, and then forwards them on to the console. It records the console video output as well as the webcam and microphone data of the tester in the same format as the PC application. The data is then uploaded, processed, and stored in secondary storage in the same manner as the PC application.

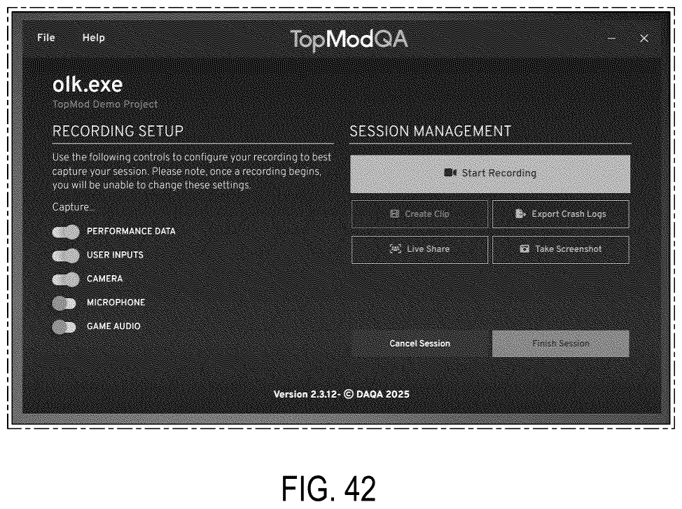

FIG. 42 shows the created session and offers users the ability to start recording by clicking on the “Start Recording” button. Users may also configure the configuration for their recording using the toggles found in the “Recording Setup” section. Once recording, users can create clips by clicking the “Create Clip” button, create crash logs by clicking the “Export Crash Logs” button, create a screenshot by clicking the “Take Screenshot” button or start live sharing their game footage by clicking the “Live Share” button. Users can finish the session by clicking the “Cancel Session” or “Finish Session” button.

FIG. 43 illustrates what happens in the session management screen (FIG. 42) once a user clicks the “Live Share” button. This button starts the live sharing functionality that provides the tester with a URL to share with a participant so they can see the targeted application being recorded and hear the testers microphone feed live through a web browser. Upon clicking the “Live Share” button (FIG. 42), the user interface of the screen changes and allows the user to either click a top banner to copy the share URL to their clipboard or click “Stop Sharing” to disable the live share functionality.

Under an embodiment, a screen shows the “Performance Analysis” page of the dashboard application. Users can configure the analysis that is performed by selecting project, application and user from the dropdown menus before clicking the “Generate” button to aggregate performance data together and display the results in the charts below. The performance charts displayed feature aggregate, over-time, data captured via TopMod QA's recording application for frames per second (FPS), CPU usage, GPU usage, network usage and memory usage. Users can click the export data button to export all of the data used to display the charts in a CSV file format.

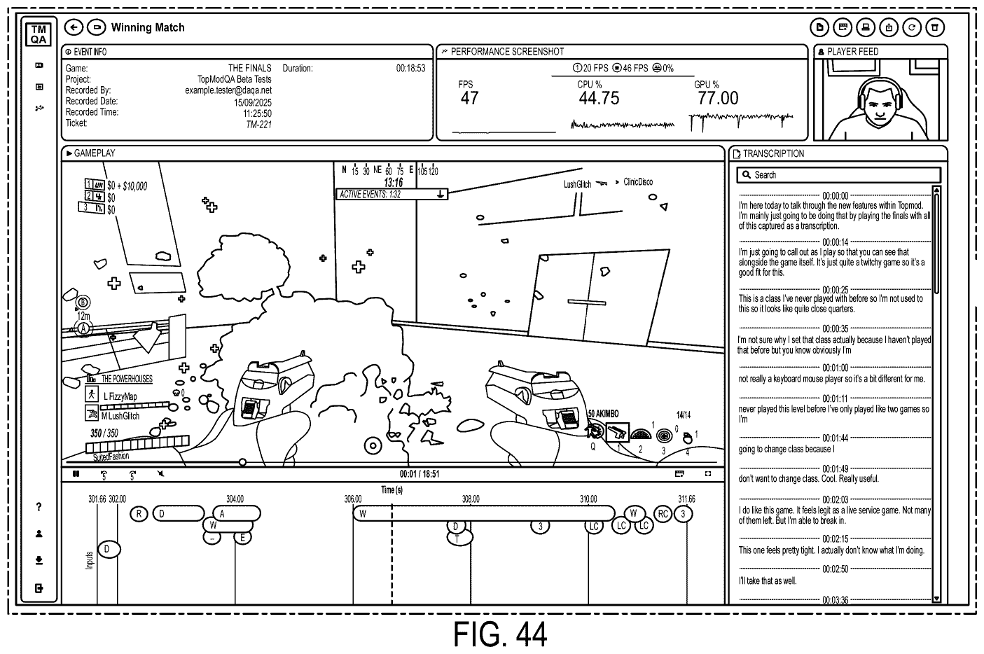

FIG. 44 shows the event page which is the primary way a user views their recorded test footage. As well as displaying the gameplay footage and audio captured, this page also displays the event information, the transcription, aggregate and over-time performance data and a timeline of the users inputs (both keyboard/mouse and controller). It also allows users to share the event via a share link, delete the event, view the composite video.

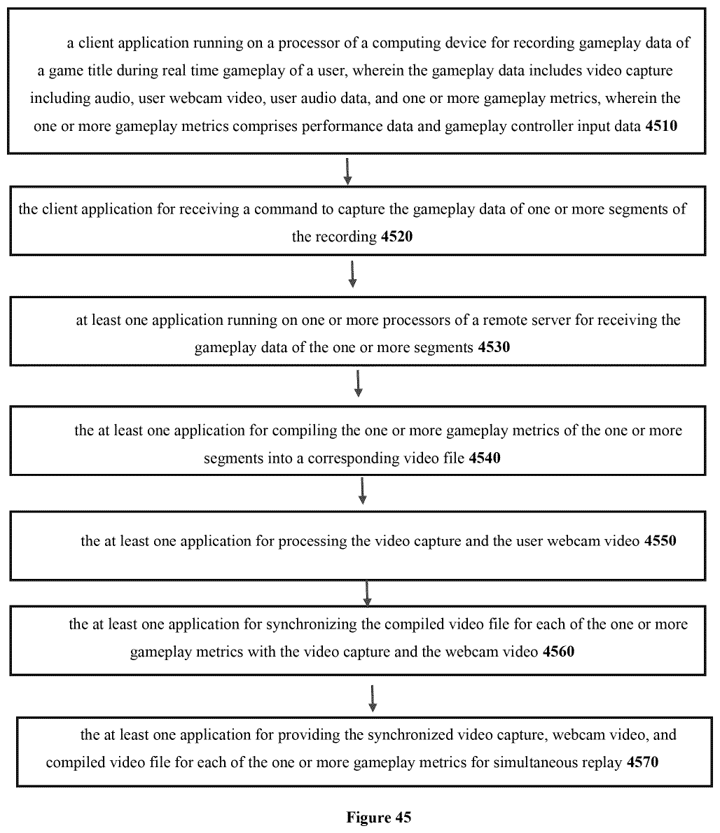

FIG. 45 shows a system including a client application running on a processor of a computing device for recording gameplay data of a game title during real time gameplay of a user, wherein the gameplay data includes video capture including audio, user webcam video, user audio data, and one or more gameplay metrics, wherein the one or more gameplay metrics comprises performance data and gameplay controller input data 4510 and for receiving a command to capture the gameplay data of one or more segments of the recording 4520. The system includes at least one application running on one or more processors of a remote server for receiving the gameplay data of the one or more segments 4530, for compiling the one or more gameplay metrics of the one or more segments into a corresponding video file 4540, for processing the video capture and the user webcam video 4550, for synchronizing the compiled video file for each of the one or more gameplay metrics with the video capture and the webcam video 4560, and for providing the synchronized video capture, webcam video, and compiled video file for each of the one or more gameplay metrics for simultaneous replay 4570.

A system is described herein comprising a client application running on a processor of a computing device for providing recording gameplay data of a game title during real time gameplay of a user, wherein the gameplay data includes video capture including audio, user webcam video, user audio data, and one or more gameplay metrics, wherein the one or more gameplay metrics comprises performance data and gameplay controller input data, receiving a command to capture the gameplay data of one or more segments of the recording, at least one application running on one or more processors of a remote server for providing, receiving the gameplay data of the one or more segments, compiling the one or more gameplay metrics of the one or more segments into a corresponding video file, processing the video capture and the user webcam video, synchronizing the compiled video file for each of the one or more gameplay metrics with the video capture and the webcam video, and providing the synchronized video capture, webcam video, and compiled video file for each of the one or more gameplay metrics for simultaneous replay.

In embodiments, the performance data comprises game frame rate as a sum of individual rendered frames in a given second.

In embodiments, the performance data comprises CPU utilization averaged once per second.

In embodiments, the performance data comprises GPU utilization averaged once per second.

In embodiments, the performance data comprises memory utilization.

In embodiments, the memory utilization comprises allocated memory by the game title under recording session.

In embodiments, the memory utilization comprises available, unallocated system memory.

In embodiments, the performance data comprises network bandwidth utilization as percentage of available throughput of the primary network adapter.

In embodiments, the gameplay controller input data comprises at least one of real time keyboard inputs, real time mouse inputs, and real time controller inputs.

In embodiments, the replay comprises a visual representation of the at least one of real time keyboard inputs, real time mouse inputs, and real time controller inputs.

In embodiments, the webcam video comprises 20 fps webcam video.

In embodiments, the user audio data comprises 96 kbps OPUS.

In embodiments, the video capture comprises 20 fps transport stream video.

In embodiments, a segment of the captured one or more segments comprises a period of time commending prior to and extending to the time of the respectively received command, wherein the period of time comprises thirty seconds or less.

In embodiments, the compiling comprises processing the performance data.

In embodiments, the processing comprises generating a graphic instance for each one second bucket of performance data.

In embodiments, the processing comprises drawing the performance data for each one second bucket onto a corresponding graphic instance and combining the graphic instances using a video file format.

In embodiments, the compiling comprises processing the controller input data.

In embodiments, the processing comprises generating a graphic instance for each one 50 ms bucket of controller input data.

In embodiments, the processing comprises drawing the controller input data for each one 50 ms bucket onto a corresponding graphic instance and combining the graphic instances using the video file format.

In embodiments, the processing the webcam video comprises scaling and padding the webcam video to specific dimensions consistent with the video file format.

In embodiments, the processing the video capture comprises scaling and padding the video capture to specific dimensions consistent with the video file format.

Computer networks suitable for use with the embodiments described herein include local area networks (LAN), wide area networks (WAN), Internet, or other connection services and network variations such as the world wide web, the public internet, a private internet, a private computer network, a public network, a mobile network, a cellular network, a value-added network, and the like. Computing devices coupled or connected to the network may be any microprocessor controlled device that permits access to the network, including terminal devices, such as personal computers, workstations, servers, mini computers, main-frame computers, laptop computers, mobile computers, palm top computers, hand held computers, mobile phones, TV set-top boxes, or combinations thereof. The computer network may include one of more LANs, WANS, Internets, and computers. The computers may serve as servers, clients, or a combination thereof.

The systems and methods for detecting code defects can be a component of a single system, multiple systems, and/or geographically separate systems. The systems and methods for detecting code defects can also be a subcomponent or subsystem of a single system, multiple systems, and/or geographically separate systems. The components of systems and methods for detecting code defects can be coupled to one or more other components (not shown) of a host system or a system coupled to the host system.

One or more components of the systems and methods for detecting code defects and/or a corresponding interface, system or application to which the systems and methods for detecting code defects is coupled or connected includes and/or runs under and/or in association with a processing system. The processing system includes any collection of processor-based devices or computing devices operating together, or components of processing systems or devices, as is known in the art. For example, the processing system can include one or more of a portable computer, portable communication device operating in a communication network, and/or a network server. The portable computer can be any of a number and/or combination of devices selected from among personal computers, personal digital assistants, portable computing devices, and portable communication devices, but is not so limited. The processing system can include components within a larger computer system.

The processing system of an embodiment includes at least one processor and at least one memory device or subsystem. The processing system can also include or be coupled to at least one database. The term “processor” as generally used herein refers to any logic processing unit, such as one or more central processing units (CPUs), digital signal processors (DSPs), application-specific integrated circuits (ASIC), etc. The processor and memory can be monolithically integrated onto a single chip, distributed among a number of chips or components, and/or provided by some combination of algorithms. The methods described herein can be implemented in one or more of software algorithm(s), programs, firmware, hardware, components, circuitry, in any combination.

The components of any system that include systems and methods for detecting code defects can be located together or in separate locations. Communication paths couple the components and include any medium for communicating or transferring files among the components. The communication paths include wireless connections, wired connections, and hybrid wireless/wired connections. The communication paths also include couplings or connections to networks including local area networks (LANs), metropolitan area networks (MANs), wide area networks (WANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

Aspects of the systems and methods for detecting code defects and corresponding systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the systems and methods for detecting code defects and corresponding systems and methods include: microcontrollers with memory (such as electronically erasable programmable read only memory (EEPROM)), embedded microprocessors, firmware, software, etc. Furthermore, aspects of the systems and methods for detecting code defects and corresponding systems and methods may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that any system, method, and/or other components disclosed herein may be described using computer aided design tools and expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.). When received within a computer system via one or more computer-readable media, such data and/or instruction-based expressions of the above described components may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of the systems and methods for detecting code defects is not intended to be exhaustive or to limit the systems and methods to the precise forms disclosed. While specific embodiments of, and examples for, the systems and methods for detecting code defects and corresponding systems and methods are described herein for illustrative purposes, various equivalent modifications are possible within the scope of the systems and methods, as those skilled in the relevant art will recognize. The teachings of the systems and methods for detecting code defects and corresponding systems and methods provided herein can be applied to other systems and methods, not only for the systems and methods described above.

The elements and acts of the various embodiments described above can be combined to provide further embodiments. These and other changes can be made to the systems and methods for detecting code defects and corresponding systems and methods in light of the above detailed description.

1. A system comprising,
a client application running on a processor of a computing device for providing,
recording gameplay data of a game title during real time gameplay of a user, wherein the gameplay data includes video capture including audio, user webcam video, user audio data, and one or more gameplay metrics, wherein the one or more gameplay metrics comprises performance data and gameplay controller input data;
receiving a command to capture the gameplay data of one or more segments of the recording;
at least one application running on one or more processors of a remote server for providing,
receiving the gameplay data of the one or more segments;
compiling the one or more gameplay metrics of the one or more segments into a corresponding video file;
processing the video capture and the user webcam video;
synchronizing the compiled video file for each of the one or more gameplay metrics with the video capture and the webcam video;
providing the synchronized video capture, webcam video, and compiled video file for each of the one or more gameplay metrics for simultaneous replay.

2. The system of claim 1, wherein the performance data comprises game frame rate as a sum of individual rendered frames in a given second.

3. The system of claim 1, wherein the performance data comprises CPU utilization averaged once per second.

4. The system of claim 1, wherein the performance data comprises GPU utilization averaged once per second.

5. The system of claim 1, wherein the performance data comprises memory utilization.

6. The system of claim 5, wherein the memory utilization comprises allocated memory by the game title under recording session.

7. The system of claim 5, wherein the memory utilization comprises available, unallocated system memory.

8. The system of claim 1, wherein the performance data comprises network bandwidth utilization as percentage of available throughput of the primary network adapter.

9. The system of claim 1, wherein the gameplay controller input data comprises at least one of real time keyboard inputs, real time mouse inputs, and real time controller inputs.

10. The system of claim 9, wherein the replay comprises a visual representation of the at least one of real time keyboard inputs, real time mouse inputs, and real time controller inputs.

11. The system of claim 1, wherein the webcam video comprises 20 fps webcam video.

12. The system of claim 1, wherein the user audio data comprises 96 kbps OPUS.

13. The system of claim 1, wherein the video capture comprises 20 fps transport stream video.

14. The system of claim 1, wherein a segment of the captured one or more segments comprises a period of time commending prior to and extending to the time of the respectively received command, wherein the period of time comprises thirty seconds or less.

15. The system of claim 1, wherein the compiling comprises processing the performance data.

16. The system of claim 15, wherein the processing comprises generating a graphic instance for each one second bucket of performance data.

17. The system of claim 16, wherein the processing comprises drawing the performance data for each one second bucket onto a corresponding graphic instance and combining the graphic instances using a video file format.

18. The system of claim 17, wherein the compiling comprises processing the controller input data.

19. The system of claim 18, wherein the processing comprises generating a graphic instance for each one 50 ms bucket of controller input data.

20. The system of claim 19, wherein the processing comprises drawing the controller input data for each one 50 ms bucket onto a corresponding graphic instance and combining the graphic instances using the video file format.

21. The system of claim 20, wherein the processing the webcam video comprises scaling and padding the webcam video to specific dimensions consistent with the video file format.

22. The system of claim 21, wherein the processing the video capture comprises scaling and padding the video capture to specific dimensions consistent with the video file format.
